(19) United States
(12) Patent Application Publication
(10) Pub. No.: US 2008/0114105 A1
(43) Pub. Date: May 15, 2008

(54) Use of Ionic Liquids or Solutions of Metal Salts in Ionic Liquids as Antistatics for Plastics

(75) Inventors: Kerstin Hell, Essen (DE); Roland Hubel, Essen (DE); Bernd Weyershausen, Essen (DE)

Correspondence Address: FROMMER LAWRENCE & HAUG, 745 FIFTH AVENUE- 10TH FL., NEW YORK, NY, 10151, US

(73) Assignee: Goldschmidt GmbH, Essen (DE)

(21) Appl. No.: 11/776,067

(22) Filed: Jul. 11, 2007

(30) Foreign Application Priority Data
Jul. 11, 2006 (DE) 10 2006 031 952.4

(51) Int. Cl. C08K 5/41

(52) U.S. Cl. 524/155; 524/236; 524/386; 524/589

(57) ABSTRACT

The invention provides for the use of ionic liquids or solutions of metal salts in ionic liquids and, if desired, diols and/or polyols as antistatics for plastics.

The invention provides antistatic formulations for plastics, in particular for polyurethanes, ionic liquids or a synergistic mixture of ionic liquids (IL), alkali metal salts and, if appropriate, further auxiliaries and additives.

Plastics such as polyolefins, e.g. low density and high density polyethylene, polypropylene, polystyrene, vinyl polymers, polyamides, polyesters, polyacetals, polycarbonates, polyvinyl chlorides and in particular polyurethanes are electrical insulators on which high surface charges can accumulate during production, processing and the use of films and moldings produced therefrom.

These static charges lead to undesirable effects and serious hazard situations which extend from attraction of dust, adhesion of hygienically problematical impurities, destruction of electronic components by arcing, physiologically unpleasant electric shocks, ignition of combustible liquids in containers or tubes in which these are stirred, poured or conveyed through to dust explosions, for example during emptying of large containers filled with dusts or flours or in quarrying of stone or mining of coal.

Ever since these plastics have been used, there has therefore been the need to prevent static charges or minimize them to such an extent that they are no longer hazardous.

A generally employed method of allowing charges to be conducted away and minimizing static charging is the use of antistatics, i.e. nonionic or ionic surface-active compounds and in particular ammonium salts and alkali metal salts.

Antistatics used nowadays are essentially external and internal antistatics.

External antistatics are applied as aqueous or alcoholic solutions to the surface of plastics by spraying, painting or dipping and subsequent drying in air. The antistatic film which remains is effective on virtually all plastics but has the disadvantage that it can very easily and unintentionally be removed again by friction or liquids.

Owing to the lack of a depot effect of the antistatic molecules migrating out from the interior of the polymer composition (as is present in the case of internal antistatics), external antistatics do not have a long-term action.

Preference is therefore given to using internal antistatics which are added to the polymer composition as far as possible in pure form, otherwise in the form of “masterbatches”, i.e. concentrated formulations, before or during processing and become homogeneously distributed therein during the injection or extrusion process.

According to present-day opinion, supported by experiments, the molecules migrate continuously to the surfaces of the polymer compositions due to their partial incompatibility and accumulate there or replace losses. The hydrophobic part remains in the polymer and the hydrophilic part binds water present in the atmosphere and forms a conductive layer which can conduct charges of not only dangerous thousands of volts but also of a few tens or hundreds of volts away to the atmosphere. This ensures that an effective amount of antistatic is present at the surface over a relatively long period of time.

However, the migration rate (diffusion rate) is a critical factor:

If it is too high, low-energy (crystalline) structures which lose the ability to bind moisture and therefore, firstly, significantly reduce the antistatic effect and, secondly, produce undesirable greasy films on the surface, with all aesthetic and processing disadvantages for, for example, the printing, packaging or food industry, can be formed.

If the migration rate is too low, an effect which is sufficient in practicable times is not achieved.

For this reason, combinations of antistatics which migrate quickly and antistatics which migrate slowly are already being used to achieve a sufficiently fast initial action and a long-term effect which lasts for weeks and months.

Typical thermoplastics have surface resistances in the range from 10¹⁶ to 10¹⁴ ohm and can therefore build up voltages of up to 15000 volt. Effective antistatics should therefore be able to reduce the surface resistances of plastics to 10¹⁰ ohm or below.

It also has to be taken into account that antistatics can influence the physical and technical properties of polymers, for example printability, sealability, thermal stability, distortion resistance or stress cracking resistance. Particularly in the case of polyurethane foams, influence of the antistatics on the cell structure and nature of the cells and thus on all physical properties is always undesirable. To minimize this effect, they should therefore be effective even in low concentrations.

Metal salts are known and effective antistatics. However, they have the disadvantage that they have to be dissolved before use in order to become homogeneously distributed in plastics. Customary solvents are alcohols, ethers, esters, polyethers, cyclic ethers, cyclic esters, amides, cyclic amides, aromatic compounds or organic solvents in general.

However, the solubility is sometimes very low, so that large amounts of solvent have to be used for sufficiently effective use concentrations.

If these antistatic formulations are used in thermoplastic and also thermoset polymers, they have the disadvantage that they have an adverse effect on the optical and especially physical properties of the end product.

In reactive multicomponent systems, as in the case of, for example, the production of polyurethanes, any reactive groups of the solvent or other constituents of the antistatic formulation can participate in an undesirable fashion in the reaction and thus, for example, alter the physical properties of the end product. For this reason, the metal salts are in practice preferably dissolved in one of the formulation constituents; in the case of polyurethanes this is generally the alcohol component, i.e. diols or polyols which are then reacted with diisocyanates or polyisocyanates to form the polymer matrix. Owing to the large number of polyols which can be used, it would then be necessary to provide a correspondingly large number of solutions. These antistatics/metal salts are therefore frequently dissolved in solvents which are a constituent of all formulations, e.g. ethylene glycol, propylene glycol or other reactive organic solvents. A disadvantage here is that the total amount of these formulation constituents which are then used not only as reactive component in the polyurethane formulation but either additionally or exclusively as solvent in the antistatic formulation in the polyurethane formulation must usually be no higher than would be the case without the addition of the antistatic formulation so as not to alter, if possible, the physical properties of the end product.

There is therefore a need in industrial practice for a solvent for metal salts which can be universally used and has a high solvent capability for many metal salts and is largely inert toward the reaction components or is also a constituent of the formulation and has no adverse effect on the physical properties of the end product.

It was therefore an object of the invention to provide a solvent having improved solvent characteristics for metal salts, with the resulting solution composed of solvent and metal salt having, advantageously improved, antistatic properties in plastics, in particular polyurethanes.

It has now surprisingly been found that particular ionic liquids are better solvents for many metal salts than are the abovementioned diols and polyols. Significantly smaller amounts of solvent are therefore necessary in the production of effective antistatic formulations in order to introduce an effective content of metal salt for improving the conductivity in plastics, in particular polyurethanes.

Furthermore, it has surprisingly been found that a combination of ionic liquids and di- or polyols or their monoalkyl or dialkyl ethers and esters, in particular ethylene glycol, butanediol, di-, tri-, tetraethylene or -propylene glycol, has a synergistic effect in respect of the solvent capability.

Furthermore, it has surprisingly been found that this synergistic combination in turn has a synergistic effect in respect of the improvement of the antistatic action in, in particular, polyurethanes.

Furthermore, it has surprisingly been found that the ionic liquids have an improved antistatic action even without dissolved metal salts.

The invention accordingly provides for the use of ionic liquids as antistatics for plastics, in particular for polyurethanes.

The invention further provides for the use of solutions of metal salts in ionic liquids as antistatics for plastics, in particular for polyurethanes.

The invention further provides for the use of solutions of metal salts in synergistic mixtures of ionic liquids and monools, diols and/or polyols and their monoalkyl or dialkyl ethers and esters, in particular ethylene glycol, butanediol, di-, tri-, tetraethylene or -propylene glycol or mixtures of monools, diols and/or polyols and their monoalkyl or dialkyl ethers and esters, in particular ethylene glycol, butanediol, di-, tri-, tetraethylene or -propylene glycol, as antistatics for plastics, in particular polyurethanes.

Further subject matters of the invention are defined by the claims.

### BRIEF DESCRIPTION OF THE DRAWINGS

FIG. 1 depicts the improvement factor based on parts of alkali metal salt in polyurethane (PU) formulation.

FIG. 2 depicts the proportion of alkali metal salt (antistatic formulation)/improvement factor.

FIG. 3 depicts the relative improvement factor on addition of antistatic formulation to the polyurethane (PU) formulation.

A preferred process according to the invention is accordingly based on the use of ionic liquids as solvent (compatibilizer) for ionizable metal salts (electrolyte salts), in particular alkali metal salts, with further organic solvents being able to be added to these mixtures in order to set a very high electrolyte salt content.

The term ionic liquids refers to salts in general which melt at low temperatures (<100° C.) and represent a novel class of liquids having a nonmolecular, ionic character. In contrast to classical salt melts, which are high-melting, highly viscous and very corrosive media, ionic liquids are liquid and have a relatively low viscosity at low temperatures (K. R. Seddon J. Chem. Technol. Biotechnol. 1997, 68, 351-356).

In most cases, ionic liquids comprise anions such as halides, carboxylates, phosphates, thiocyanate, isothiocyanate, dicyanamide, sulfate, alkylsulfates, sulfonates, alkylsulfonates, tetrafluoroborate, hexafluorophosphate or bis(trifluoromethylsulfonyl)imide combined with, for example, substituted ammonium, phosphonium, pyridinium or imidazolium cations; the abovementioned anions and cations represent a small selection from among the large number of possible anions and cations and thus make no claim of completeness or constitute any restriction.

The ionic liquids used according to the invention are composed of at least one quaternary nitrogen and/or phosphorus compound and at least one anion and their melting point is below about +250° C., preferably below about +150° C., in particular below about +100° C. The mixtures of IL+solvent are liquid at room temperature.

The ionic liquids which are preferably used in the process of the invention comprise at least one cation of the general formula:

R¹R²R³R⁴N⁺ (1)

R¹R²N⁺=CR³R⁴ (2)

R¹R²R³R⁴P⁺ (3)

R¹R²P⁺=CR³R⁴ (4)

where
R¹, R², R³, R⁴ are identical or different and are each hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms, a linear or branched aliphatic hydrocarbon radical which has from 2 to 30 carbon atoms and may contain double bonds and is interrupted by one or more heteroatoms (oxygen, NH, NR′ where R′ is a C₁—C₃₀-alkyl radical which may contain double bonds, in particular —CH₃), a linear or branched aliphatic hydrocarbon radical which has from 2 to 30 carbon atoms and may contain double bonds and is interrupted by one or more functions selected from the group consisting of —O—C(O)—, —(O)C—O—, —NH—C(O)—, —(O)C—NH, —(CH₃)N—C(O)—, —(O)C—N (CH₃)—, —S(O₂)—O—, —O—S(O₂)—, —S(O₂)—NH—, —NH—S(O₂)—, —S(O₂)—N(CH₃)—, —N(CH₃)—S(O₂)—, a linear or branched aliphatic or cycloaliphatic hydrocarbon radical which has from 1 to 30 carbon atoms and may contain double bonds and is functionalized by terminal OH, OR′, NH₂, N(H)R′, N(R′)₂ groups (where R′ is a C₁—C₃₀-alkyl radical which may contain double bonds) or a polyether —(R⁵—O)ₙ—R⁶ having a blockwise or random structure,
   where
R⁵ is a linear or branched hydrocarbon radical containing from 2 to 4 carbon atoms,
n is from 1 to 100, preferably from 2 to 60, and
R⁶ is hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms or a radical —C(O)—R⁷, where
   R⁷ is a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms or an alkylaryl radical having from 7 to 40 carbon atoms.

Further possible cations are ions derived from saturated or unsaturated cyclic compounds or from aromatic compounds having, in each case, at least one trivalent nitrogen atom in a 4- to 10-membered, preferably 5- or 6-membered, heterocyclic ring which may be substituted. Such cations can be described in simplified form (i.e. without the precise position and number of double bonds in the molecule being specified) by the general formulae (5), (6) and (7) below, where the heterocyclic rings may, if desired, also be able to contain a plurality of heteroatoms

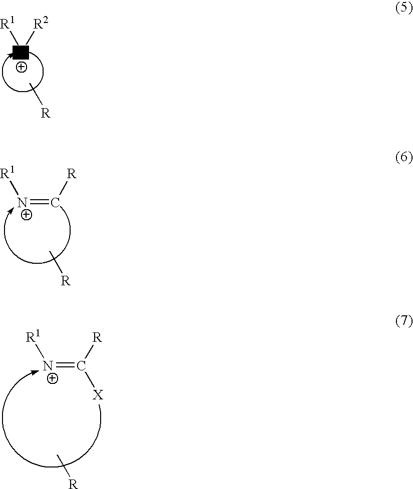

and the substituents have the following meanings:
R is a hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms or an alkylaryl radical having from 7 to 40 carbon atoms.
R¹ and R² have the abovementioned meanings,
R^{1a} is hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical which has from 6 to 40 carbon atoms, an alkylaryl radical having from 7 to 40 carbon atoms, a linear or branched aliphatic hydrocarbon radical which has from 2 to 30 carbon atoms and may contain double bonds and is interrupted by one or more heteroatoms (oxygen, NH, NR′ where R′ is a C₁—C₃₀-alkyl radical which may contain double bonds, in particular —CH₃), a linear or branched aliphatic hydrocarbon radical which has from 2 to 30 carbon atoms and may contain double bonds and is interrupted by functions selected from the group consisting of —O—C(O)—, —(O)C—O—, —NH—C(O)—, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)—, a linear or branched aliphatic or cycloaliphatic hydrocarbon radical which has from 1 to 30 carbon atoms and may contain double bonds and is functionalized by terminal OH, OR′, NH₂, N(H)R′, N(R′)₂ groups (where R′ is a C₁—C₃₀-alkyl radical which may contain double bonds) or a polyether —(R⁵—O)ₙ—R⁶ having a blockwise or random structure,
X is an oxygen atom, a sulfur atom or a substituted nitrogen atom (X=O, S, NR^{1a}).

Examples of cyclic nitrogen compounds of the abovementioned type are pyrrolidine, dihydropyrrole, pyrrole, imidazoline, oxazoline, oxazole, thiazoline, thiazole, isoxazole, isothiazole, indole, carbazole, piperidine, pyridine, the isomeric picolines and lutidines, quinoline and isoquinoline. The cyclic nitrogen compounds of the general formulae (5), (6) and (7) can be unsubstituted (R=H), monosubstituted or polysubstituted by the radical R, where in the case of multiple substitution by R the individual radicals R can be different.

Further possible cations are ions derived from saturated acyclic, saturated or unsaturated cyclic compounds and from aromatic compounds having, in each case, more than one trivalent nitrogen atom in a 4- to 10-membered, preferably 5- to 6-membered, heterocyclic ring. These compounds can be substituted both on the carbon atoms and on the nitrogen atoms. They can also have substituted or unsubstituted benzene rings and/or cyclohexane rings fused onto them to form polycyclic structures. Examples of such compounds are pyrazole, 3,5-dimethylpyrazole, imidazole, benzimidazole, N-methylimidazole, dihydropyrazole, pyrazolidine, pyridazine, pyrimidine, pyrazine, pyridazine, pyrimidine, 2,3-, 2,5- and 2,6-dimethylpyrazine, cimoline, phthalazine, quinazoline, phenazine and piperazine. In particular, cations of the general formula (8) derived from imidazole and its alkyl and phenyl derivatives have been found to be useful as constituents of the ionic liquid.

Further possible cations are ions which contain two nitrogen atoms and are represented by the general formula (8)

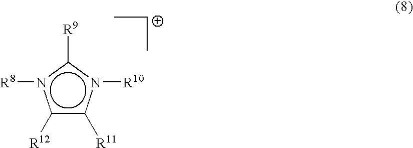

where
R⁸, R⁹, R¹⁰, R¹¹, R¹² are identical or different and are each hydrogen, a linear or branched aliphatic hydrocarbon radical which has from 1 to 30, preferably from 1 to 8, in particular from 1 to 4, carbon atoms and may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms, a linear or branched aliphatic hydrocarbon radical which has from 1 to 30 carbon atoms and may contain double bonds and is interrupted by one or more heteroatoms (oxygen, NH, NR′ where R′ is a C₁—C₃₀-alkyl radical which may contain double bonds), a linear or branched aliphatic hydrocarbon radical which has from 1 to 30 carbon atoms and may contain double bonds and is interrupted by one or more functions selected from the group consisting of —O—C(O)—, —(O)C—O—, —NH—C(O)—, —(O)C—NH, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)—, a linear or branched aliphatic or cycloaliphatic hydrocarbon radical which has from 1 to 30 carbon atoms and may contain double bonds and is functionalized by terminal OH, OR′, NH₂, N(H)R′, N(R′)₂ groups where R′ is a C₁—C₃₀-alkyl radical which may contain double bonds or a polyether —(R⁵—O)ₙ—R⁶ which has a blockwise or random structure,
   where
R⁵ is a hydrocarbon radical containing from 2 to 4 carbon atoms,
n is from 1 to 100 and
R⁶ is hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms or a radical —C(O)—R⁷, where
   R⁷ is a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms or an alkylaryl radical having from 7 to 40 carbon atoms.

The ionic liquids which are preferably used according to the invention comprise at least one of the abovementioned cations combined with in each case an anion. Preferred anions are selected from the group consisting of, without making any claim as to completeness, halides, bis(perfluoroalkylsulfonyl)-amides or -imides such as bis(trifluoromethylsulfonyl)-imide, alkyltosylates and aryltosylates, perfluoro-alkyltosylates, nitrate, sulfate, hydrogensulfate, alkylsulfates and arylsulfates, polyether sulfates and sulfonates, perfluoroalkylsulfates, sulfonate, alkylsulfonates and arylsulfonates, perfluorinated alkylsulfonates and arylsulfonates, alkylcarboxylates and arylcarboxylates, perfluoroalkylcarboxylates, perchlorate, tetrachloroaluminate, saccharinate. Further preferred anions are dicyanamide, thiocyanate, isothiocyanate, tetraphenylborate, tetrakis(pentafluorophenyl)borate, tetrafluoroborate, hexafluorophosphate, polyether phosphates and phosphate.

It is critical that the components (IL(s)+electrolyte salt(s)+solvent) are present in the ready-to-use mixture which is used according to the invention as antistatic in plastics in an amount sufficient for the mixture to contain a very high proportion of electrolyte salt(s) and preferably be liquid at <100° C., particularly preferably at room temperature.

Preference is given according to the invention to ionic liquids or mixtures thereof which are a combination of a 1,3-dialkylimidazolium, 1,2,3-trialkylimidazolium, 1,3-dialkylimidazolinium and 1,2,3-trialkylimidazolinium cation with an anion selected from the group consisting of halides, bis(trifluoromethylsulfonyl)imide, perfluoroalkyltosylates, alkylsulfates and alkylsulfonates, perfluorinated alkylsulfonates and alkylsulfates, perfluoroalkylcarboxylates, perchlorate, dicyanamide, thiocyanate, isocyanate, tetraphenylborate, tetrakis(pentafluorophenyl)borate, tetrafluoroborate, hexafluorophosphate. It is also possible to use simple, commercially available, acyclic quaternary ammonium salts such as TEGO® IL T16ES, TEGO® IL K5MS or Rezol Heqams (products of Goldschmidt GmbH).

To produce the synergistically acting combinations, the ionic liquids are used together with, in particular, diols selected from the group consisting of ethylene glycol, propylene glycol, butylene glycol, diethylene glycol, triethylene glycol, tetraethylene glycol, dipropylene glycol, tripropylene glycol, tetrapropylene glycol and the corresponding monoalkyl and dialkyl ethers.

Preferred synergistic combinations comprise at least one or more ionic liquids selected from the group consisting of 1,3-dialkylimidazolium and 1,3-dialkylimidazolinium salts and one or more diols and/or polyols selected from the group consisting of ethylene glycol, propylene glycol, polyetherols and also an alkali metal salt.

Particular preference is given according to the invention to combinations of at least one ionic liquid and at least one diol selected from the group consisting of ethylene glycol, diethylene glycol and butanediol.

The mixing ratio of ionic liquid to the alcohol component can be varied within relatively wide limits and is influenced both by the structure of the two components and by the electrolyte salt which is concomitantly used. However, since the proportion of foreign material in the plastics should be kept very low for the abovementioned reasons, the proportion of alcohol component is preferably kept in the lower range at which a synergistic action can still just be achieved.

In general, reliable results are achieved using ternary mixtures at a mixing ratio of ionic liquid to the alcohol component in the range from about 1:10 to 10:1. In such a mixture, the alkali metal salt should be present in a proportion of from 0.1 to 75% by weight, preferably a proportion of from 0.5 to 50% by weight, particularly preferably a proportion of from 5 to 30% by weight.

The salts which are concomitantly used according to the invention are the simple or complex compounds customarily used in this field, for example, in particular, alkali metal salts of the anions: bis(perfluoroalkylsulfonyl)amide or -imide, e.g. bis(trifluoromethylsulfonyl)imide, alkyltosylates and aryltosylates, perfluoroalkyltosylates, nitrate, sulfate, hydrogensulfate, alkylsulfates and arylsulfates, polyether sulfates and sulfonates, perfluoroalkylsulfates, sulfonate, alkylsulfonates and arylsulfonates, perfluorinated alkylsulfonates and arylsulfonates, alkylcarboxylates and arylcarboxylates, perfluoroalkylcarboxylates, perchlorate, tetrachloroaluminate, saccharinate, preferably anions of the compounds thiocyanate, isothiocyanate, dicyanamide, tetraphenylborate, tetrakis(pentafluorophenyl)borate, tetrafluoroborate, hexafluorophosphate, phosphate and polyether phosphates.

Preferred mixtures are, in particular, those which contain NaSCN or NaN(CN)₂ and KPF₆ as alkali metal salt and an imidazolinium or imidazolium salt, preferably 1-ethyl-3-methylimidazolium ethylsulfate (EMIM ES) as IL, e.g. EMIM ES/NaN(CN)₂ or EMIM ES/NaN(CN)₂/EG.

Examples According to the Invention:

Materials used:

KPF₆ potassium hexafluorophosphate

NaN(CN)₂ sodium dicyanamide

NaSCN sodium thiocyanate

KSCN potassium thiocyanate

LiBTA lithium bis(trifluoromethylsulfonyl)imide

EG ethylene glycol

EP-S 89 7% of KPF₆ in ethylene glycol

Ionic liquids (IL)

| | |
|---|---|
| TEGO ® IL T16ES | Ethylbis(polyethoxyethanol) (tallow |
| | alkyl) ammonium ethylsulfate |
| BMIM TC | 1-Butyl-3-methylimidazolium thiocyanate |
| EMIM BR | 1-Ethyl-3-methylimidazolium bromide |
| MMIM MS | 1,3-Dimethylimidazolium methylsulfate |
| EMIM ES | 1-Ethyl-3-methylimidazolium ethylsulfate |

Equipment used:

The synergistic mixture of ionic liquid, electrolyte salt and organic solvent was produced by means of a simple magnetic stirrer in the laboratory. Stirring is continued until a clear solution is obtained.

Preparation of the Mixtures:

To prepare formulations according to the invention, the individual constituents of the formulation are melted at room temperature or sometimes also at elevated temperature if necessary, mixed and stirred well until a clear solution is formed. The solution may have to be heated a little before use.

Production of the Polyurethane Test Specimens:

To test an additive/additive mixture for antistatic action, a test specimen is produced from polyurethane according to the following formulation:

Weights of Constituents:

| | | | |
|---|---|---|---|
| 1) | Desmodur ® 2001 KS (polyol OHN = 56) | 100 | parts |
| 2) | Ethylene glycol (EG) | 12 | parts |
| 3) | Water (deionized) | 1 | part |
| 4) | Triethylenediamine (TEDA) 25% | 1.6 | parts |
| | strength in ethylene glycol | | |
| 5) | Tegostab ® B 8951 | 0.6 | part |
| 6) | Antistatic, varies | | |
| 7) | Desmodur ® PM 53 W (isocyanate | 140.3 | parts |
| | content 19%) | | |

The amount of ethylene glycol present in the antistatic is taken into account in the calculation of the formulation. The amount of isocyanate is adapted according to the OH number of the antistatic.

Procedure:

1 to 6 are weighed together into a cardboard cup and stirred at 1000 rpm for 1 minute. Desmodur® 2001 KS and Desmodur® PM 53 W are preheated to 40° C. The isocyanate (7) is subsequently added and the mixture is stirred at 2500 rpm for 7 seconds. The contents of the cup are then poured completely within 8-9 seconds into a mold (20 cm×10 cm×4 cm) which has been heated to 50° C. and is subsequently closed immediately. The mold had previously been sprayed with a commercial mold release agent for polyurethane foams. After 5 minutes, the test specimen is removed from the mold and briefly wiped with dry cleaning paper.

Measurement of the Surface Resistance (Measurement Voltage 100 V):

All test specimens are stored under standard conditions of temperature and humidity (23° C., 50% atmospheric humidity). 72 hours after having been produced, the surface resistance of the test specimens is determined by means of a resistance measuring instrument (high-ohm measuring instrument HM 307 from Fetronic GmbH). The surface resistance of the test specimen is measured three times on the upper side and three times on the underside. The mean of these values is calculated. The test specimen is subsequently cut into two parts (thickness a: 2.7 cm, thickness b: 1.2 cm). The surface resistance is then measured three times on each of the cut surfaces and the mean is calculated in each case. The measured values read off directly from the instrument are reported in ohm [Ω] . The blank (test specimen without antistatic) is in each case determined afresh before an associated measurement series.

The ratio of the resistance (mean; see above) of the test specimen without antistatic (blank) and the resistance of the respective test specimen with antistatic gives the improvement factor (ImF) as mean of the three values obtained in each case (complete block, 2.7 cm block and 1.2 cm block).

The relative improvement factor (ImFᵣₑₗ) is defined as:

$${ImF}_{rel} = \frac{Improvement factor}{( Proportion of alkali metal salt / 0.1 )}$$

The proportion of alkali metal salt in the overall formulation (see column 4 in Tables 1 to 13) is calculated from the product of the proportion by weight of the alkali metal salt in the antistatic (see column 2 in Tables 1 to 13) and the amount used (parts) of the antistatic (see column 3 in Tables 1 to 13). The relative improvement factor thus reflects the effectiveness of the inorganic active component (alkali metal salt) per 0.1 part of alkali metal salt when 2, 4, 6 and 8 parts of antistatic formulations are added.

Combinations:

Invention: IL+metal salt and IL+diol+metal salt

Comparison: Diol+metal salt (EP-S 89 and 20 NT)

TABLE 1

3° ND = equimolar NaN(CN)₂/EMIM ES + same proportion by
mass of EG

TABLE 2

3° NT = equimolar NaSCN/EMIM ES + same proportion by
mass of EG

TABLE 3

2° NT = maximum concentration (35%) of NaSCN in EG

TABLE 4

EP-S 89 = 7% KPF₆ in EG

TABLE 5

Ternary mixtures (MMIM MS/EG/LiBTA)

TABLE 6

Ternary mixtures (MMIM MS/EG/various electrolyte salts)

TABLE 7

Ternary mixtures (EMIM MS/EG/various electrolyte salts)

TABLE 8

Ternary mixtures (various ILs/EG/KPF₆)

TABLE 9

Binary mixture (BMIM BR/LiBTA)

TABLE 10

Ternary mixture = equimolar KPF₆/MMIM ES + same
proportion by mass of EG

TABLE 11

Pure IL BMIM TC

TABLE 12

Maximum content of electrolyte salt in IL (EMIM ES)

TABLE 13

Maximum content of various electrolyte salts in ternary
mixtures (EG/EMIM ES/electrolyte salt)

Results:

TABLE 1
3° ND = equimolar NaN(CN)₂/EMIM ES + same proportion by mass of EG

| | | | | [O] | [O] | [O] | | |
|---|---|---|---|---|---|---|---|---|
| | | | Corresponds | entire block | 2.7 cm section | 1.2 cm section | | |
| Experiment | Antistatic | Parts of | to parts | Ø from 6 | Ø from 3 | Ø from 3 | | |
| No. | 3° ND | antistatic | of salt | measurements | measurements | measurements | ImF | ImFᵣₑₗ |
| | Blank | — | — | 4.58E+11 | 8.17E+11 | 6.17E+11 | | |
| 1 | 21.8 g of EMIM ES; | 2 | 0.273 | 4.77E+09 | 5.67E+09 | 3.53E+09 | | |
| | 30.0 g of EG; | | | | | | | |
| | 8.2 g of NaN(CN)₂ | | | | | | | |
| | (13.6%) | | | | | | | |
| | | | | 9.62E+01 | 1.44E+02 | 1.75E+02 | 138 | 51 |
| 2 | 21.8 g of EMIM ES; | 4 | 0.544 | 2.15E+09 | 2.25E+09 | 1.52E+09 | | |
| | 30.0 g of EG; | | | | | | | |
| | 8.2 g of NaN(CN)₂ | | | | | | | |
| | (13.6%) | | | | | | | |
| | | | | 2.13E+02 | 3.63E+02 | 4.07E+02 | 328 | 60 |
| 3 | 21.8 g of EMIM ES; | 6 | 0.82 | 1.01E+09 | 1.02E+09 | 5.67E+08 | | |
| | 30.0 g of EG; | | | | | | | |
| | 8.2 g of NaN(CN)₂ | | | | | | | |
| | (13.6%) | | | | | | | |
| | | | | 4.54E+02 | 8.03E+02 | 1.09E+03 | 782 | 95 |
| 4 | 21.8 g of EMIM ES; | 8 | 1.09 | 4.38E+08 | 3.83E+08 | 2.30E+08 | | |
| | 30.0 g of EG; | | | | | | | |
| | 8.2 g of | | | | | | | |
| | (13.6%) | | | | | | | |
| | | | | 1.05E+03 | 2.13E+03 | 2.68E+03 | 1952 | 180 |

The greater the number of parts of the ternary mixture EMIM ES/EG/NaN(CN)₂ used in the PU formulation, the greater the improvement factor. Synergistic effect. Exponential increase in the conductivity.

TABLE 2
3° NT = equimolar NaSCN/EMIM ES + same proportion by mass of EG

| | | | | [O] | [O] | [O] | | |
|---|---|---|---|---|---|---|---|---|
| | | | Corresponds | entire block | 2.7 cm section | 1.2 cm section | | |
| Experiment | Antistatic | Parts of | to parts | Ø from 6 | Ø from 3 | Ø from 3 | | |
| No. | 3° ND | antistatic | of salt | measurements | measurements | measurements | ImF | ImFᵣₑₗ |
| | Blank | — | — | 4.58E+11 | 8.17E+11 | 6.17E+11 | | |
| 5 | 22.3 g of EMIM ES; | 2 | 0.265 | 1.90E+10 | 6.77E+09 | 3.60E+09 | | |
| | 30.0 g of EG; | | | | | | | |
| | 7.7 g of NaSCN | | | | | | | |
| | (12.8%) | | | | | | | |
| | | | | 2.42E+01 | 1.21E+02 | 1.71E+02 | 105 | 40 |
| 5a | 30 g of EMIM ES; | 2 | 0 | 2.20E+10 | 7.77E+09 | 4.20E+09 | | |
| | 30.0 g of EG | | | | | | | |
| | | | | 2.09E+01 | 1.05E+02 | 1.47E+02 | 91 | |
| 6 | 22.3 g of EMIM ES; | 4 | 0.53 | 2.78E+09 | 2.57E+09 | 1.53E+09 | | |
| | 30.0 g of EG; | | | | | | | |
| | 7.7 g of NaSCN | | | | | | | |
| | (12.8%) | | | | | | | |
| | | | | 1.65E+02 | 3.18E+02 | 4.02E+02 | 295 | 56 |
| 6a | 30 g of EMIM ES; | 4 | 0 | 3.18E+09 | 2.77E+09 | 2.33E+09 | | |
| | 30.0 g of EG | | | | | | | |
| | | | | 1.44E+02 | 2.95E+02 | 2.64E+02 | 234 | |
| 7 | 22.3 g of EMIM ES; | 6 | 0.8 | 1.16E+09 | 1.02E+09 | 7.23E+08 | | |
| | 30.0 g of EG; | | | | | | | |
| | 7.7 g of NaSCN | | | | | | | |
| | (12.8%) | | | | | | | |
| | | | | 3.95E+02 | 8.03E+02 | 8.53E+02 | 684 | 86 |
| 8 | 22.3 g of EMIM ES; | 8 | 1.06 | 5.17E+08 | 4.47E+08 | 2.20E+08 | | |
| | 30.0 g of EG; | | | | | | | |
| | 7.7 g of | | | | | | | |
| | (12.8%) | | | | | | | |
| | | | | 8.87E+02 | 1.83E+03 | 2.80E+03 | 1839 | 173 |

The greater the number of parts of the ternary mixture EMIM ES/EG/NaSCN used in the PU formulation, the greater the improvement factor. Synergistic effect. Exponential increase in the conductivity.

TABLE 3
2° ND = maximum concentration of NaSCN in EG

| | | | | [O] | [O] | [O] | | |
|---|---|---|---|---|---|---|---|---|
| | | | Corresponds | entire block | 2.7 cm section | 1.2 cm section | | |
| Experiment | Antistatic | Parts of | to parts | Ø from 6 | Ø from 3 | Ø from 3 | | |
| No. | 2° ND | antistatic | of salt | measurements | measurements | measurements | ImF | ImFᵣₑₗ |
| | Blank | — | — | 4.58E+11 | 8.17E+11 | 6.17E+11 | | |
| 9 | 50 g of EG | 2 | 0.7 | 8.70E+09 | 6.53E+09 | 5.73E+09 | | |
| | 27 g of NaSCN | | | | | | | |
| | (35 wt %) | | | | | | | |
| | | | | 5.27E+01 | 1.25E+02 | 1.08E+02 | 95 | 14 |
| 10 | 50 g of EG | 4 | 1.4 | 2.13E+09 | 8.27E+09 | 1.40E+09 | | |
| | 27 g of NaSCN | | | | | | | |
| | (35 wt %) | | | | | | | |
| | | | | 2.15E+02 | 9.88E+01 | 4.40E+02 | 251 | 18 |
| 11 | 50 g of EG | 6 | 2.1 | 7.00E+08 | 6.10E+08 | 4.97E+08 | | |
| | 27 g of NaSCN | | | | | | | |
| | (35 wt %) | | | | | | | |
| | | | | 6.55E+02 | 1.34E+03 | 1.24E+03 | 1078 | 51 |
| 12 | 50 g of EG | 8 | 2.8 | 2.43E+08 | 2.70E+08 | 1.77E+08 | | |
| | 27 g of NaSCN | | | | | | | |
| | (35 wt %) | | | | | | | |
| | | | | 1.89E+03 | 3.02E+03 | 3.49E+03 | 2802 | 100 |

The improvement effect per 0.1 part of salt in the PU formulation is lower than in the case of a ternary mixture comprising an ionic liquid/EG/alkali metal salt.

TABLE 4
EP-S 89 = 7% KPF₆ in EG

| | | | | [O] | [O] | [O] | | |
|---|---|---|---|---|---|---|---|---|
| | | | Corresponds | entire block | 2.7 cm section | 1.2 cm section | | |
| Experiment | Antistatic | Parts of | to parts | Ø from 6 | Ø from 3 | Ø from 3 | | |
| No. | E-PS 89 | antistatic | of salt | measurements | measurements | measurements | ImF | ImFᵣₑₗ |
| | Blank | — | — | 4.58E+11 | 8.17E+11 | 6.17E+11 | | |
| 13 | 7% of KPF₆ in EG | 2.86 | 0.2 | 1.22E+10 | 1.20E+10 | 7.80E+09 | | |
| | | | | 3.77E+01 | 6.81E+01 | 7.91E+01 | 62 | 31 |
| 14 | 7% of KPF₆ in EG | 3.77 | 0.264 | 9.22E+09 | 9.03E+09 | 6.00E+09 | | |
| | | | | 4.97E+01 | 9.04E+01 | 1.03E+02 | 81 | 31 |
| 15 | 7% of KPF₆ in EG | 5.7 | 0.4 | 5.83E+09 | 8.67E+09 | 6.33E+09 | | |
| | | | | 7.86E+01 | 9.42E+01 | 9.74E+01 | 90 | 23 |
| 16 | 7% of KPF₆ in EG | 7.4 | 0.5 | 6.04E+09 | 7.50E+09 | 4.27E+09 | | |
| | | | | 7.59E+01 | 1.09E+02 | 1.45E+02 | 110 | 22 |

The improvement factor becomes smaller; the more is used, the smaller the increase in conductivity; in addition, the improvement factor per 0.1 part of alkali metal salt is significantly lower than in the case of a ternary mixture using anionic liquid.

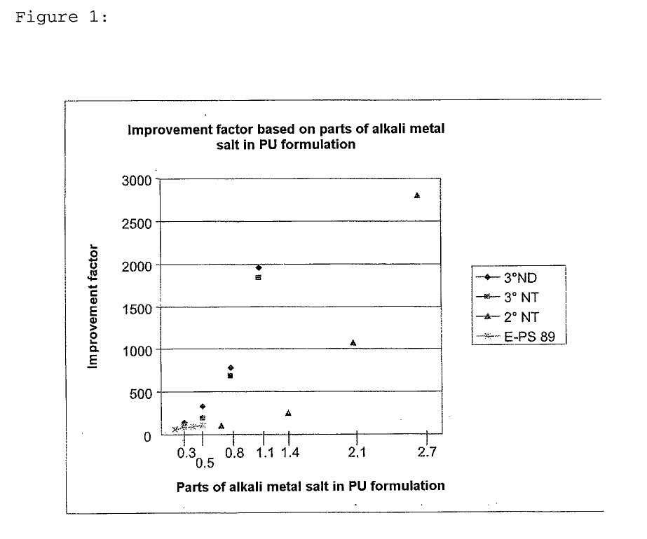

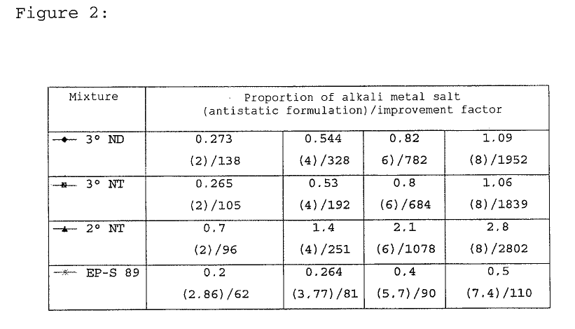

The results from Tables 1 to 4 are shown graphically in FIGS. 1 and 2:

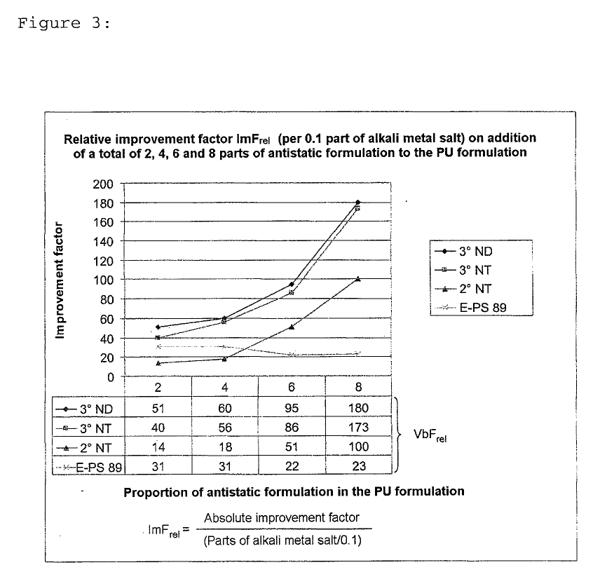

In the presentation in FIG. 3, the limitation imposed by the use of EP-S 89 is made particularly clear. To achieve the maximum absolute improvement factor achieved here of 110, it was necessary to add 8 parts of the antistatic formulation to the PU formulation, but this incorporated only 0.5 part of alkali metal salt into the system. In the case of the two ternary mixtures 3° ND and 3° NT, 1.09 and 1.06 parts, respectively, of alkali metal salt were incorporated into the PU formulation by addition of 8 parts of antistatic formulation. The fact that a synergistic effect occurs here is surprising since the improvement factor per 0.1 part of alkali metal salt increases exponentially.

FIG. 3 shows the change in the relative improvement factor as a function of the amount (parts) of antistatic formulation added. While in the case of mixtures comprising ionic liquids, the relative improvement factor increases with increasing amount of antistatic formulation, it decreases when using mixture EP-S 89 which comprises no ionic liquid.

1. The greater the number of parts of the ternary mixture 3° ND and 3° NT used in the PU formulation, the greater the improvement factor! Synergistic effect. Exponential increase in the conductivity.

2. In the case of the binary mixture 2° NT, the improvement effect per 0.1 part of salt in the PU formulation is lower than in the case of a ternary mixture {IL/EG/alkali metal salt}.

3. In the case of EP-S 89, the relative improvement factor decreases with increasing proportion of antistatic in the overall formulation, i.e. the more is used, the lower the increase in conductivity. This is equivalent to a saturation effect. The increase in the conductivity is not directly proportional to the amount used. In addition, the relative improvement factor per 0.1 part of alkali metal salt is significantly less than in the case of a ternary mixture using an ionic liquid.

TABLE 5
Ternary mixtures (MMIM MS/EG/LiBTA)

| | | | | [O] | [O] | [O] | | |
|---|---|---|---|---|---|---|---|---|
| | | | Corresponds | entire block | 2.7 cm section | 1.2 cm section | | |
| Experiment | | Parts of | to parts | Ø from 6 | Ø from 3 | Ø from 3 | | |
| No. | Antistatic | antistatic | of salt | measurements | measurements | measurements | ImF | ImFᵣₑₗ |
| | Blank | — | — | 2.82E+11 | 5.23E+11 | 3.65E+11 | | |
| 17 | 4.2 g of MMIM MS; | 1 | 0.290 | 3.55E+09 | 6.67E+09 | 4.47E+09 | | |
| | 10 g of EG; 5.8 g | | | | | | | |
| | of LiBTA (29%) | | | | | | | |
| | | | | 79 | 79 | 82 | 80 | 28 |
| 18 | 2.9 g of MMIM MS; | 1 | 0.195 | 6.72E+09 | 1.01E+10 | 7.17E+09 | | |
| | 14 g of EG; 4.1 g | | | | | | | |
| | of LiBTA (19.5%) | | | | | | | |
| | | | | 42 | 52 | 51 | 48 | 25 |
| | Blank | — | — | 4.58E+11 | 8.17E+11 | 6.17E+11 | | |
| 19 | 4.2 g of MMIM MS; | 2 | 0.58 | 1.21E+09 | 1.72E+09 | 1.31E+09 | | |
| | 10 g of EG; 5.8 g | | | | | | | |
| | of LiBTA (29%) | | | | | | | |
| | | | | 378 | 476 | 471 | 441 | 76 |
| 20 | 4.2 g of MMIM MS; | 4 | 1.16 | 8.28E+08 | 1.31E+09 | 9.73E+08 | | |
| | 10 g of EG; 5.8 g | | | | | | | |
| | of LiBTA (29%) | | | | | | | |
| | | | | 553 | 623 | 634 | 603 | 52 |
| 21 | 4.2 g of MMIM MS; | 6 | 1.74 | 9.58E+08 | 1.17E+09 | 1.02E+09 | | |
| | 10 g of EG; 5.8 g | | | | | | | |
| | of LiBTA (29%) | | | | | | | |
| | | | | 478 | 700 | 607 | 595 | 34 |

In the case of the ternary mixtures (MMIM MS/EG/LiBTA), it can be seen that the conductivity (measured by the improvement factors per 0.1 part of salt) decreases as more parts of the mixture are used in the PU formulation.

TABLE 6
Ternary mixtures (MMIM MS/EG/various electrolyte salts)

| | | | | [O] | [O] | [O] | | |
|---|---|---|---|---|---|---|---|---|
| | | | Corresponds | entire block | 2.7 cm section | 1.2 cm section | | |
| Experiment | | Parts of | to parts | Ø from 6 | Ø from 3 | Ø from 3 | | |
| No. | Antistatic | antistatic | of salt | measurements | measurements | measurements | ImF | ImFᵣₑₗ |
| | Blank | — | — | 2.95E+11 | 5.23E+11 | 3.65E+11 | | |
| 22 | 7 g of MMIM MS; | 1 | 0.15 | 8.22E+09 | 1.33E+10 | 1.05E+10 | | |
| | 10 g of EG; | | | | | | | |
| | 3 g of NaN(CN)₂ | | | | | | | |
| | (15%) | | | | | | | |
| | | | | 34 | 39 | 35 | 36 | 24 |
| 23 | 4.9 g of MMIM MS; | 1 | 0.1 | 1.40E+10 | 2.55E+10 | 1.47E+10 | | |
| | 14 g of EG; | | | | | | | |
| | 2.1 g of NaN(CN)₂ | | | | | | | |
| | (10%) | | | | | | | |
| | | | | 20 | 21 | 25 | 22 | 22 |
| 24 | 5.3 g of MMIM MS; | 1 | 0.235 | 8.70E+09 | 1.12E+10 | 8.83E+09 | | |
| | 10 g of EG; | | | | | | | |
| | 4.7 g of KPF₆ | | | | | | | |
| | (23.5%) | | | | | | | |
| | | | | 32 | 47 | 41 | 40 | 17 |
| 25 | 3.7 g of MMIM MS; | 1 | 0.157 | 1.47E+10 | 2.15E+10 | 1.72E+10 | | |
| | 14 g of EG; | | | | | | | |
| | 3.3 g of KPF₆ | | | | | | | |
| | (15.7%) | | | | | | | |
| | | | | 19 | 24 | 21 | 22 | 14 |
| 26 | 6.5 g of MMIM MS; | 1 | 0.175 | 9.57E+09 | 1.57E+10 | 1.15E+10 | | |
| | 10 g of EG; | | | | | | | |
| | 3.5 g of NaBF₄ | | | | | | | |
| | (17.5%) | | | | | | | |
| | | | | 29 | 33 | 32 | 32 | 18 |
| 27 | 4.6 g of MMIM MS; | 1 | 0.114 | 1.11E+10 | 2.08E+10 | 1.35E+10 | | |
| | 14 g of EG; | | | | | | | |
| | 2.4 g of NaBF₄ | | | | | | | |
| | (11.4%) | | | | | | | |
| | | | | 25 | 25 | 27 | 26 | 23 |
| 28 | 7.2 g of MMIM MS; | 1 | 0.14 | 8.87E+09 | 1.53E+10 | 7.43E+09 | | |
| | 10 g of EG; | | | | | | | |
| | 2.8 g of NaSCN | | | | | | | |
| | (14%) | | | | | | | |
| | | | | 32 | 34 | 49 | 38 | 27 |
| 29 | 5 g of MMIM MS; | 1 | 0.095 | 1.33E+10 | 2.37E+10 | 1.40E+10 | | |
| | 14 g of EG; | | | | | | | |
| | 2 g of NaSCN | | | | | | | |
| | (9.5%) | | | | | | | |
| | | | | 21 | 22 | 26 | 23 | 24 |

In the case of the ternary mixtures (MMIM MS/EG/electrolyte salt), it is found that the mixtures having the higher salt concentration (the lower proportion of EG) are the most conductive measured by the improvement factors per 0.1 part of salt.

TABLE 7
Ternary mixtures (EMIM ES/EG/various electrolyte salts)

| | | | | [O] | [O] | [O] | | |
|---|---|---|---|---|---|---|---|---|
| | | | Corresponds | entire block | 2.7 cm section | 1.2 cm section | | |
| Experiment | | Parts of | to parts | Ø from 6 | Ø from 3 | Ø from 3 | | |
| No. | Antistatic | antistatic | of salt | measurements | measurements | measurements | ImF | ImFᵣₑₗ |
| | Blank | — | — | 3.42E+11 | 7.17E+11 | 4.77E+11 | | |
| 30 | 4.5 g of EMIM ES; | 1 | 0.275 | 6.58E+09 | 1.04E+10 | 6.17E+09 | | |
| | 10 g of EG; 5.5 g of | | | | | | | |
| | LiBTA (27.5%) | | | | | | | |
| | | | | 52 | 69 | 77 | 66 | 24 |
| 31 | 3.2 g of EMIM ES; | 1 | 0.181 | 8.35E+09 | 1.30E+10 | 7.23E+09 | | |
| | 14 g of EG; 3.8 g | | | | | | | |
| | LiBTA (18.1%) | | | | | | | |
| | | | | 41 | 55 | 66 | 54 | 30 |
| 32 | 7.3 g of EMIM ES; | 1 | 0.135 | 2.42E+10 | 1.30E+10 | 1.11E+10 | | |
| | 10 g of EG; 2.7 g | | | | | | | |
| | of NaN(CN)₂ | | | | | | | |
| | (13.5%) | | | | | | | |
| | | | | 14 | 55 | 43 | 37 | 27 |
| 33 | 5.1 g of EMIM ES; | 1 | 0.09 | 1.66E+10 | 1.87E+10 | 1.30E+10 | | |
| | 14 g of EG; 1.9 g of | | | | | | | |
| | NaN(CN)₂(9%) | | | | | | | |
| | | | | 21 | 38 | 37 | 32 | 36 |
| 34 | 5.6 g of EMIM ES; | 1 | 0.22 | 9.17E+09 | 1.20E+10 | 8.17E+09 | | |
| | 10 g of EG; 4.4 g of | | | | | | | |
| | KPF₆(22%) | | | | | | | |
| | | | | 37 | 60 | 58 | 52 | 24 |
| 35 | 3.9 g of EMIM ES; | 1 | 0.148 | 1.10E+10 | 1.25E+10 | 1.10E+10 | | |
| | 14 g of EG; 3.1 g of | | | | | | | |
| | KPF₆(14.8%) | | | | | | | |
| | | | | 31 | 57 | 43 | 44 | 30 |
| 36 | 6.8 g of EMIM ES; | 1 | 0.16 | 1.20E+10 | 1.83E+10 | 1.20E+10 | | |
| | 10 g of EG; 3.2 g of | | | | | | | |
| | NaBF₄(16%) | | | | | | | |
| | | | | 28 | 39 | 40 | 36 | 23 |
| 37 | 4.8 g of EMIM ES; | 1 | 0.105 | 1.75E+10 | 2.47E+10 | 1.60E+10 | | |
| | 14 g of EG; 2.2 g of | | | | | | | |
| | NaBF₄(10.5%) | | | | | | | |
| | | | | 20 | 29 | 30 | 26 | 25 |
| 38 | 7.5 g of EMIM ES; | 1 | 0.125 | 1.24E+10 | 1.67E+10 | 1.17E+10 | | |
| | 10 g of EG; 2.5 g of | | | | | | | |
| | NaSCN (12.5%) | | | | | | | |
| | | | | 27 | 43 | 41 | 37 | 30 |
| 39 | 5.2 g of EMIM ES; | 1 | 0.086 | 1.69E+10 | 2.35E+10 | 1.57E+10 | | |
| | 14 g of EG; 1.8 g of | | | | | | | |
| | NaSCN (8.6%) | | | | | | | |
| | | | | 20 | 30 | 30 | 27 | 31 |

TABLE 8
Ternary mixtures (various ILs/EG/KPF₆)

| | | | | [O] | [O] | [O] | | |
|---|---|---|---|---|---|---|---|---|
| | | | Corresponds | entire block | 2.7 cm section | 1.2 cm section | | |
| Experiment | | Parts of | to parts | Ø from 6 | Ø from 3 | Ø from 3 | | |
| No. | Antistatic | antistatic | of salt | measurements | measurements | measurements | ImF | ImFᵣₑₗ |
| | Blank | — | — | 3.92E+11 | 6.30E+11 | 4.77E+11 | | |
| 40 | 40 g of TEGO IL | 1 | 0.15 | 2.08E+10 | 3.00E+10 | 2.15E+10 | | |
| | T16ES | | | | | | | |
| | 10 g of EG, 9 g of | | | | | | | |
| | KPF₆ (15%) | | | | | | | |
| | | | | 19 | 21 | 22 | 21 | 14 |
| 41 | 40 g of TEGO IL | 2 | 0.30 | 1.01E+10 | 1.50E+10 | 1.10E+10 | | |
| | T16ES | | | | | | | |
| | 10 g of EG, | | | | | | | |
| | 9 g of KPF₆(15%) | | | | | | | |
| | | | | 39 | 42 | 43 | 41 | 14 |
| 42 | 40 g of TEGO IL | 3 | 0.45 | 7.72E+09 | 8.93E+09 | 6.83E+09 | | |
| | T16ES | | | | | | | |
| | 10 g of EG, 9 g of | | | | | | | |
| | KPF₆ (15%) | | | | | | | |
| | | | | 51 | 71 | 70 | 64 | 14 |
| 43 | 40 g of TEGO IL | 4 | 0.60 | 6.75E+09 | 8.33E+09 | 5.90E+09 | | |
| | T16ES | | | | | | | |
| | 10 g of EG, 9 g of | | | | | | | |
| | KPF₆ (15%) | | | | | | | |
| | | | | 58 | 76 | 81 | 71 | 12 |
| 44 | 40 g of TEGO IL | 1 | 0.15 | 2.08E+10 | 3.00E+10 | 2.15E+10 | | 14 |
| | T16ES | | | | | | | |
| | 10 g of EG, 9 g of | | | | | | | |
| | KPF₆(15%) | | | | | | | |
| 45 | 3.7 g of MMIM MS; | 1 | 0.157 | 1.47E+10 | 2.15E+10 | 1.72E+10 | | 14 |
| | 14 g of EG; 3.3 g | | | | | | | |
| | of KPF₆(15.7%) | | | | | | | |
| 46 | 3.9 g of EMIM ES; | 1 | 0.148 | 1.10E+10 | 1.25E+10 | 1.10E+10 | | 30 |
| | 14 g of EG; 3.1 g | | | | | | | |
| | of KPF₆(14.8%) | | | | | | | |

At a virtually equal proportion of KPF₆ in the PU formulation, the choice of the ionic liquid has a great influence on the conductivity of the PU foam or the improvement factor to be achieved. EMIM ES is significantly more effective than MMIM MS.

TABLE 9
Binary mixture (BMIM BR/LiBTA)

| | | | | [O] | [O] | [O] | | |
|---|---|---|---|---|---|---|---|---|
| | | | Corresponds | entire block | 2.7 cm section | 1.2 cm section | | |
| Experiment | | Parts of | to parts | Ø from 6 | Ø from 3 | Ø from 3 | | |
| No. | Antistatic | antistatic | of salt | measurements | measurements | measurements | ImF | ImFᵣₑₗ |
| | Blank | — | — | 3.55E+11 | 7.67E+11 | 5.00E+11 | | |
| 47 | 18 g of BMIM BR | 1 | 0.1 | 7.20E+09 | 1.12E+10 | 6.53E+09 | | |
| | 2 g of LiBTA (10%) | | | | | | | |
| | | | | 49 | 69 | 77 | 65 | 65 |
| 48 | 18 g of BMIM BR | 2 | 0.2 | 4.45E+09 | 5.27E+09 | 4.42E+09 | | |
| | 2 g of LiBTA (10%) | | | | | | | |
| | | | | 80 | 146 | 113 | 113 | 57 |
| 49 | 18 g of BMIM BR | 3 | 0.3 | 2.77E+09 | 5.83E+09 | 3.57E+09 | | |
| | 2 g of LiBTA (10%) | | | | | | | |
| | | | | 128 | 131 | 140 | 133 | 44 |
| 50 | 18 g of BMIM BR | 4 | 0.4 | 2.10E+09 | 3.67E+09 | 2.20E+09 | | |
| | 2 g of LiBTA (10%) | | | | | | | |
| | | | | 169 | 209 | 227 | 202 | 51 |

The relative improvement factor decreases, the more parts of the mixture are used in the PU formulation (saturation effect). However, BMIM BR has a positive effect on the conductivity of the foam compared to (MMIM/EMIM MS/ES//EG) mixtures.

TABLE 10
Ternary mixture = equimolar KPF₆/MMIM ES + same proportion by mass of EG

| | | | | [O] | [O] | [O] | | |
|---|---|---|---|---|---|---|---|---|
| | | | Corresponds | entire block | 2.7 cm section | 1.2 cm section | | |
| Experiment | | Parts of | to parts | Ø from 6 | Ø from 3 | Ø from 3 | | |
| No. | Antistatic | antistatic | of salt | measurements | measurements | measurements | ImF | ImFᵣₑₗ |
| | Blank | — | — | 2.95E+11 | 5.23E+11 | 3.65E+11 | | |
| 51 | 5.3 g of MMIM MS; | 1 | 0.235 | 8.70E+09 | 1.12E+10 | 8.83E+09 | | |
| | 10 g of EG; 4.7 g of | | | | | | | |
| | KPF₆(23.5%) | | | | | | | |
| | | | | 32 | 47 | 41 | 40 | 17 |
| | Blank | — | — | 4.58E+11 | 8.17E+11 | 6.17E+11 | | |
| 52 | 5.3 g of MMIM MS; | 2 | 0.47 | 4.98E+09 | 5.13E+09 | 4.37E+09 | | |
| | 10 g of EG; 4.7 g of | | | | | | | |
| | KPF₆(23.5%) | | | | | | | |
| | | | | 9.21E+01 | 1.59E+02 | 1.41E+02 | 131 | 28 |
| 53 | 5.3 g of MMIM MS; | 4 | 0.94 | 3.03E+09 | 4.37E+09 | 2.70E+09 | | |
| | 10 g of EG; 4.7 g | | | | | | | |
| | of KPF₆(23.5%) | | | | | | | |
| | | | | 1.51E+02 | 1.87E+02 | 2.28E+02 | 189 | 20 |
| 54 | 5.3 g of MMIM MS; | 6 | 1.41 | 1.95E+09 | 2.55E+09 | 1.57E+09 | | |
| | 10 g of EG; 4.7 g | | | | | | | |
| | of KPF₆(23.5%) | | | | | | | |
| | | | | 2.35E+02 | 3.20E+02 | 3.92E+02 | 316 | 22 |
| 55 | 5.3 g of MMIM MS; | 7.6 | 1.786 | 1.39E+09 | 1.82E+09 | 1.10E+09 | | |
| | 10 g of EG; 4.7 g | | | | | | | |
| | of KPF₆(23.5%) | | | | | | | |
| | | | | 3.29E+02 | 4.50E+02 | 5.59E+02 | 446 | 25 |

The greater the number of parts of antistatic used, the greater the conductivity (linear relationship).

TABLE 11
Pure IL BMIM TC:

| | | | | [O] | [O] | [O] | | |
|---|---|---|---|---|---|---|---|---|
| | | | Corresponds | entire block | 2.7 cm section | 1.2 cm section | | |
| Experiment | | Parts of | to parts | Ø from 6 | Ø from 3 | Ø from 3 | | |
| No. | Antistatic | antistatic | of salt | measurements | measurements | measurements | ImF | ImFᵣₑₗ |
| | Blank | — | — | 4.58E+11 | 8.17E+11 | 6.17E+11 | | |
| 56 | BMIM SCN | 2 | | 2.71E+09 | 2.05E+09 | 2.47E+09 | | |
| | | | | 1.69E+02 | 3.98E+02 | 2.50E+02 | 273 | — |
| 57 | BMIM SCN | 4 | | 1.17E+09 | 1.07E+09 | 4.68E+09 | | |
| | | | | 3.93E+02 | 7.66E+02 | 1.32E+02 | 430 | — |

TABLE 12
Maximum content of electrolyte salt in IL (EMIM ES)

| | | | | [O] | [O] | [O] | | |
|---|---|---|---|---|---|---|---|---|
| | | | Corresponds | entire block | 2.7 cm section | 1.2 cm section | | |
| Experiment | | Parts of | to parts | Ø from 6 | Ø from 3 | Ø from 3 | | |
| No. | Antistatic | antistatic | of salt | measurements | measurements | measurements | ImF | ImFᵣₑₗ |
| | Blank | — | — | 4.58E+11 | 8.17E+11 | 6.17E+11 | | |
| 58 | 20.0 g of EMIM ES | 4 | 0.67 | 1.48E+09 | 1.53E+09 | 1.16E+09 | | |
| | 4 g of NaN(CN)₂ | | | | | | | |
| | (16.7%) | | | | | | | |
| | | | | | | | 420 | 63 |
| 59 | 20.0 g of EMIM ES | 8 | 1.34 | 6.75E+08 | 6.13E+08 | 6.17E+08 | | |
| | 4 g of NaN(CN)₂ | | | | | | | |
| | (16.7%) | | | | | | | |
| | | | | | | | 789 | 59 |
| 60 | 20.0 g of EMIM ES | 4 | 0.364 | 2.05E+09 | 2.20E+09 | 1.60E+09 | | |
| | 2 g of NaSCN | | | | | | | |
| | (9.1%) | | | | | | | |
| | | | | | | | 304 | 83 |
| 61 | 20.0 g of EMIM ES | 8 | 0.728 | 9.87E+08 | 1.15E+09 | 4.30E+08 | | |
| | 2 g of NaSCN | | | | | | | |
| | (9.1%) | | | | | | | |
| | | | | | | | 1132 | 155 |
| 62 | 20 g of EMIM ES | 2 | 0.131 | 7.83E+09 | 1.08E+10 | 5.37E+09 | | |
| | 1.4 g of KSCN | | | | | | | |
| | (6.5%) | | | | | | | |
| | | | | 5.85E+01 | 7.59E+01 | 1.15E+02 | 83 | 63 |
| 63 | 20 g of EMIM ES | 6 | 0.393 | 1.92E+09 | 2.50E+09 | 2.73E+09 | | |
| | 1.4 g of KSCN | | | | | | | |
| | (6.5%) | | | | | | | |
| | | | | 2.39E+02 | 3.27E+02 | 2.26E+02 | 264 | 67 |

The absolute values of the conductivity of the PU foam are high, but without EG clear solutions of the salt in the pure ionic liquid are not obtained at these alkali metal salt concentrations; the relative improvement factors are lower than for the corresponding ternary mixtures.

TABLE 13
Maximum content of various electrolyte salts in ternary mixtures (EG/EMIM ES/electrolyte salt)

| | | | | [O] | [O] | [O] | | |
|---|---|---|---|---|---|---|---|---|
| | | | Corresponds | entire block | 2.7 cm section | 1.2 cm section | | |
| Experiment | | Parts of | to parts | Ø from 6 | Ø from 3 | Ø from 3 | | |
| No. | Antistatic | antistatic | of salt | measurements | measurements | measurements | ImF | ImFᵣₑₗ |
| | Blank | — | — | 4.58E+11 | 8.17E+11 | 6.17E+11 | | |
| 64 | 9.2 g of EMIM ES | 4 | 1.62 | 1.45E+09 | 1.73E+09 | 1.05E+09 | 464 | 29 |
| | 20.55 g of EG | | | | | | | |
| | 20.25 g of KSCN | | | | | | | |
| | (40.5%) | | | | | | | |
| 65 | 9.2 g of EMIM ES | 8 | 3.24 | 8.55E+08 | 1.16E+09 | 7.93E+08 | 614 | 19 |
| | 20.55 g of EG | | | | | | | |
| | 20.25 g of KSCN | | | | | | | |
| | (40.5%) | | | | | | | |
| 66 | 8.17 g of EMIM ES | 4 | 1.344 | 3.87E+09 | 7.17E+09 | 2.57E+09 | 189 | 14 |
| | 16.8 g of NaSCN | | | | | | | |
| | (33.6 wt %) | | | | | | | |
| | 25.0 g of EG | | | | | | | |
| 67 | 8.17 g of EMIM ES | 8 | 2.688 | 9.00E+08 | 1.08E+09 | 7.93E+08 | 614 | 23 |
| | 16.8 g of NaSCN | | | | | | | |
| | (33.6 wt %) | | | | | | | |
| | 25.0 g of EG | | | | | | | |

Very high concentrations of electrolyte salt in the ternary mixtures are not necessarily associated with significantly higher conductivities or larger relative improvement factors. The relative improvement factors are in fact significantly smaller than in the case of mixtures in which electrolyte salt and ionic liquid are mixed in equimolar amounts.

Summary Assessment:

1. The greater the number of parts of the ternary mixture 3° ND and 3° NT used in the PU formulation, the greater the improvement factor! Synergistic effect. Exponential increase in the conductivity (Tables 1 and 2).

2. In the case of the binary mixture 2° NT, the improvement effect per 0.1 part of salt in the PU formulation is lower than in the case of a ternary mixture {IL/EG/alkali metal salt} (Table 3).

3. In the case of EP-S 89, the relative improvement factor decreases with increasing proportion of antistatic in the overall formulation, i.e. the more is used, the lower the increase in conductivity. This is equivalent to a saturation effect. The increase in the conductivity is not directly proportional to the amount used. In addition, the relative improvement factor per 0.1 part of alkali metal salt is significantly less than in the case of a ternary mixture using anionic liquid (Table 4).

4. In the case of the ternary mixtures (MMIM MS/EG/LiBTA), it can be seen that the conductivity measured by the relative improvement factor decreases as more parts of the antistatic are used in the PU formulation. This makes it possible to conclude that the above-described synergistic effect becomes significantly more apparent when using NaSCN and NaN(CN)₂ than when using LiBTA (Table 5).

5. When ternary mixtures (MMIM MS/EG/electrolyte salt) containing various electrolyte salts but the same IL are used (Table 6), it is found that the mixtures having the higher alkali metal salt content (or the lower proportion of EG) are the more conductive, measured by the relative improvement factors. Surprisingly, exactly the opposite effect is observed when using EMIM ES as IL. When EMIM ES is used, it is the ternary mixtures having a lower alkali metal salt content which are the more effective, measured by the relative improvement factors. In addition, this series of experiments (Tables 6 and 7) demonstrates that the salts NaSCN and NaN(CN)₂ in such ternary mixtures produce a greater relative improvement factor than the alkali metal salts NaBF₄ and KPF₆.

6. The results summarized in Table 8 demonstrate that EMIM ES is a more effective IL than MMIM MS and TEGO IL T16ES in ternary antistatics.

7. Table 11: When binary mixtures (IL+electrolyte salt, without EG) are used, the absolute values of the conductivity of the PU foam are high, but without EG clear solutions of the alkali metal in the pure ionic liquid cannot be obtained at these alkali metal salt concentrations. Furthermore, the relative improvement factors are smaller than for the corresponding ternary mixtures.

1. The use of ionic liquids as antistatics for plastics.

2. The use of solutions of metal salts in ionic liquids as antistatics for plastics.

3. The use of solutions of metal salts in synergistic mixtures of ionic liquids and diols and/or polyols as antistatics for plastics.

4. The use of ionic liquids or solutions of metal salts in synergistic mixtures of ionic liquids and diols and/or polyols as antistatics for polyurethanes.

5. The use of ionic liquids or solutions of metal salts in ionic liquids as antistatics for plastics, wherein the ionic liquids comprise at least one cation of the general formulae (1) to (4):
R¹R²R³R⁴N⁺ (1)
R¹R²N⁺=CR³R⁴ (2)
R¹R²R³R⁴P⁺ (3)
R¹R²P⁺=CR³R⁴ (4)
where
R¹, R², R³, R⁴ are identical or different and are each hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms, a linear or branched aliphatic hydrocarbon radical which has from 2 to 30 carbon atoms and may contain double bonds and is interrupted by one or more heteroatoms (oxygen, NH, NR′ where R′ is a C₁—C₃₀-alkyl radical which may contain double bonds), a linear or branched aliphatic hydrocarbon radical which has from 2 to 30 carbon atoms and may contain double bonds and is interrupted by one or more functions selected from the group consisting of —O—C(O)—, —(O)C—O—, —NH—C(O)—, —(O)C—NH, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)—, a linear or branched aliphatic or cycloaliphatic hydrocarbon radical which has from 1 to 30 carbon atoms and may contain double bonds and is functionalized by terminal OH, OR′, NH₂, N(H)R′, N(R′)₂ groups (where R′ is a C₁—C₃₀-alkyl radical which may contain double bonds) or a polyether —(R⁵—O)ₙ—R⁶ having a blockwise or random structure, where
R⁵ is a linear or branched hydrocarbon radical containing from 2 to 4 carbon atoms,
n is from 1 to 100 and
R⁶ is hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms or a radical —C(O)—R⁷, where
R⁷ is a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms or an alkylaryl radical having from 7 to 40 carbon atoms.

6. The use of ionic liquids or solutions of metal salts in ionic liquids as claimed in claim 5, wherein cations are used which are derived from saturated or unsaturated cyclic compounds or from aromatic compounds having, in each case, at least one trivalent nitrogen atom in a 4- to 10-membered, heterocyclic ring of the general formulae (5), (6) and (7), where the heterocyclic rings may, if desired, also be able to contain further heteroatoms 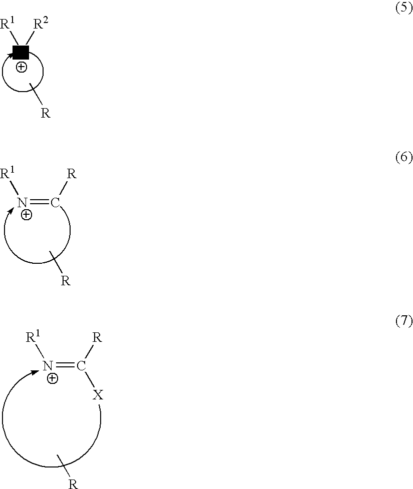
and in which the substituents have the following meanings:
R is a hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms or an alkylaryl radical having from 7 to 40 carbon atoms,
R¹ and R² have the abovementioned meanings,
R^{1a} is hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical which has from 6 to 40 carbon atoms, an alkylaryl radical having from 7 to 40 carbon atoms, a linear or branched aliphatic hydrocarbon radical which has from 2 to 30 carbon atoms and may contain double bonds and is interrupted by one or more heteroatoms (oxygen, NH, NR′ where R′ is a C₁—C₃₀-alkyl radical which may contain double bonds, in particular —CH₃), a linear or branched aliphatic hydrocarbon radical which has from 2 to 30 carbon atoms and may contain double bonds and is interrupted by one or more functions selected from the group consisting of —O—C(O)—, —(O)C—O—, —NH—C(O)—, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)—, a linear or branched aliphatic or cycloaliphatic hydrocarbon radical which has from 1 to 30 carbon atoms and may contain double bonds and is functionalized by terminal OH, OR′, NH₂, N(H)R′, N(R′)₂ groups (where R′ is a Cₗ—C₃₀-alkyl radical which may contain double bonds) or a polyether —(R⁵—O)ₙ—R⁶ having a blockwise or random structure,
X is an oxygen atom, a sulfur atom or a substituted nitrogen atom (X=O, S, NR^{1a}).

7. The use of ionic liquids or solutions of metal salts in ionic liquids as claimed in either claim 5 or 6 as antistatics for polyurethanes.

8. The use of ionic liquids or solutions of metal salts in ionic liquids as antistatics for plastics as claimed in at least one of claims 1 to 4, wherein the ionic liquids comprise a cation of the general formula (8) 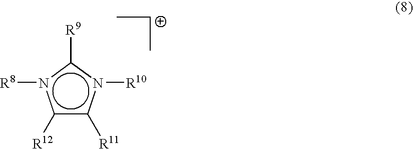
where
R⁸, R⁹, R¹⁰, R¹¹, R¹² are identical or different and are each hydrogen, a linear or branched aliphatic hydrocarbon radical which has from 1 to 30, preferably from 1 to 8, in particular from 1 to 4, carbon atoms and may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms, a linear or branched aliphatic hydrocarbon radical which has from 1 to 30 carbon atoms and may contain double bonds and is interrupted by one or more heteroatoms (oxygen, NH, NR′ where R∝ is a C₁—C₃₀-alkyl radical which may contain double bonds), a linear or branched aliphatic hydrocarbon radical which has from 1 to 30 carbon atoms and may contain double bonds and is interrupted by one or more functions selected from the group consisting of —O—C(O)—, —(O)C—O—, —NH—C(O)—, —(O)C—NH, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)—, a linear or branched aliphatic or cycloaliphatic hydrocarbon radical which has from 1 to 30 carbon atoms and may contain double bonds and is functionalized by terminal OH, OR′, NH₂, N(H)R′, N(R′)₂ groups (where R₄₀ is a C₁—C₃₀-alkyl radical which may contain double bonds) or a polyether —(R⁵—O)ₙ—R⁶ which has a blockwise or random structure, where
R⁵ is a hydrocarbon radical containing from 2 to 4 carbon atoms,
n is from 1 to 100 and
R⁶ is hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms or a radical —C(O)—R⁷, where
R⁷ is a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms or an alkylaryl radical having from 7 to 40 carbon atoms.

9. The use of ionic liquids or solutions of metal salts in ionic liquids as claimed in at least one of claims 5 to 8, wherein the ionic liquids contain an anion selected from the group consisting of halides, bis(perfluoroalkylsulfonyl)amides or -imides such as bis(trifluoromethylsulfonyl)imide, alkyltosylates and aryltosylates, perfluoroalkyltosylates, nitrate, sulfate, hydrogensulfate, alkylsulfates and arylsulfates, polyether sulfates and sulfonates, perfluoroalkylsulfates, sulfonate, alkylsulfonates and arylsulfonates, perfluorinated alkylsulfonates and arylsulfonates, alkylcarboxylates and arylcarboxylates, perfluoroalkylcarboxylates, perchlorate, tetrachloroaluminate, saccharinate, preferably anions of the compounds thiocyanate, isothiocyanate, dicyanamide, tetraphenylborate, tetrakis(pentafluorophenyl)borate, tetrafluoroborate, hexafluorophosphate, phosphate and polyether phosphates.

10. The use of ionic liquids or solutions of metal salts in ionic liquids as claimed in at least one of claims 1 to 4, wherein the ionic liquids contain a cation selected from among compounds of the general formulae (1) and/or (7) and a dicyanamide, thiocyanate, isothiocyanate, hexafluorophosphate anion.

11. The use of ionic liquids or solutions of metal salts in ionic liquids as claimed in at least one of claims 1 to 10, wherein mixtures of two or more ionic liquids comprising cations of the general formulae (1) to (8) in each case combined with at least one anion are used.

12. The use of solutions of metal salts in ionic liquids as claimed in at least one of claims 2 to 11, wherein these contain, as electrolyte salts, at least one salt selected from the group consisting of, in particular, alkali metal salts with the anions bis(perfluoroalkylsulfonyl)amide or -imide such as bis(trifluoromethylsulfonyl)imide, alkyltosylates and aryltosylates, perfluoroalkyltosylates, nitrate, sulfate, hydrogensulfate, alkylsulfates and arylsulfates, polyether sulfates and sulfonates, perfluoroalkylsulfates, sulfonate, alkylsulfonates and arylsulfonates, perfluorinated alkylsulfonates and arylsulfonates, alkylcarboxylates and arylcarboxylates, perfluoroalkylcarboxylates, perchlorate, tetrachloroaluminate, saccharinate, thiocyanate, isothiocyanate, dicyanamide, tetraphenylborate, tetrakis(pentafluorophenyl)borate, tetrafluoroborate, hexafluorophosphate, phosphate and polyether phosphates.
